(19) United States
(12) Patent Application Publication
(10) Pub. No.: US 2005/0086194 A1
(43) Pub. Date: Apr. 21, 2005

(54) Information reference apparatus, information reference system, information reference method, information reference program and computer readable information recording medium

(75) Inventors: Shigehiko Suzuki, Kawasaki (JP); Masanori Uchida, Kawasaki (JP); Yasunori Ushio, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/788,486

(22) Filed: Mar. 1, 2004

(30) Foreign Application Priority Data
Oct. 20, 2003 (JP) 2003-359121

(51) Int. Cl. G06F 7/00

(52) U.S. Cl. 707/1

(57) ABSTRACT

An information reference apparatus includes: a reference information storage part storing predetermined reference information; a reference range defining information storage part storing predetermined reference range defining information; and a reference range defining part referring to the reference range defining information stored for a user by the reference range defining information storage part and defining a range of the reference information stored by the reference information storage part, in which range the reference information is available for the user to refer to.

### BACKGROUND OF THE INVENTION

1. Field of the Invention

The present invention relates to an information reference apparatus, an information reference system, an information reference method, an information reference program and a computer readable information recording medium, and in particular, to an information reference apparatus, an information reference system and an information reference method by which it is possible to effectively reduce a load borne by each user concerning information processing in a network environment.

2. Description of the Related Art

In the recent information age, there is provided an environment for users to easily access various sorts of information. However, various issues may also occur such that a time is required for appropriately handling a large amount of information which each user obtains, or so. Specifically, in case where many electronic mails are received, for example, the importance of each received mail depends on each particular user who received it, a work of analyzing and determining, each time of reception, how important each received mail is, may include sometimes a troublesome work. Furthermore, there occurs a possibility in such a situation that reading of the most important mail may be missed because of such a large amount of information to be handled, for example.

Further, recently various sorts of information is made accessible by means of a communication network such as the Internet or so. However, when a particular user searches for truly required information therefrom, the user needs to repeat try and error with adding/modifying search key words/search conditions in the search work, in general. As a result, a considerable time may be needed for reaching the truly required information.

Furthermore, in general, in an own terminal PC, URLs of particular homepages or so, which a particular user frequently accesses are registered, and with a use of the thus-registered information, it may become easier to obtain required information. However, if a situation occurs in which the user particular should use a terminal PC which originally belongs to another user, the particular user cannot utilize the above-mentioned his or her registered information, and thus, he/she should make an extra work such as newly performing keyword search or tracing a linkage to reach a desired homepage.

### SUMMARY OF THE INVENTION

The present invention has been devised in consideration of these issues, and an object of the present invention is to provide an information processing system in which a predetermined information management rule prepared specially for each particular user is applied, given information is automatically selected according to this previously registered information management rule, and as a result, only a limited range of information which is truly required for the particular user is made accessible by him/her.

For achieving this object, according to the present invention, a reference information storage part storing predetermined reference information; a reference range defining information storage part storing predetermined reference range defining information; and a reference range defining part referring to the reference range defining information stored for a user by said reference range defining information storage part and defining a range of the reference information stored by said reference information storage part, in which range the reference information is available for the user to refer to are provided.

Thereby, the range of information which is accessible by a terminal of each user is automatically defined by the reference range defining part. Thereby, each user should read merely the information within the thus-defined range, and thus, the user is made free from a work of selecting a range of information which has a high importance for him/her from among a large amount of information given. Further, in this case, the above-mentioned operation of defining the range of information which is accessible for each user performed by the reference range defining part is performed based on the reference range defining information previously stored. Accordingly, the range of information which is suitable for each user can be appropriately defined. As a result, the information which is truly required for each user can be positively specified, and also, it is possible to avoid a problematic situation from occurring in which even important information is missed from being read. As a result, each user is provided with an environment in which he or she can effectively obtain only necessary information for him or her without fail.

Furthermore, by providing the above-mentioned reference range defining information storage part in a predetermined server, even a particular user makes a work with a use of a terminal apparatus of another user, the reference range defining information for the particular user is automatically applied when the above-mentioned server is accessed by him or her. Thereby, the above-mentioned advantages can also be provided in the same manner as that in which the particular user uses his or her own terminal apparatus even when actually the terminal apparatus of another user is borrowed. Thus, a user can be provided with an environment enabling him or her to be allowed to utilize the efficient information acquisition function achieved by the above-mentioned information range defining information prepared specially for himself or herself even when the user borrows a machine of another user.

### BRIEF DESCRIPTION OF DRAWINGS

Other objects and further features of the present invention will become more apparent from the following detailed description when read in conjunction with the accompanying drawings:

FIG. 1 shows a system configuration of one embodiment of the present invention;

FIG. 2 shows details of a data storage manner in the embodiment shown in FIG. 1;

FIG. 3 shows a format of a received information table in the embodiment shown in FIG. 1;

FIG. 4 shows a format of a body information table in the embodiment shown in FIG. 1;

FIG. 5 shows a format of an attached file table in the embodiment shown in FIG. 1;

FIG. 6 shows a format of an access permission requirement table in the embodiment shown in FIG. 1;

FIG. 7 shows a format of a personal dispatch management table in the embodiment shown in FIG. 1;

FIG. 8 shows a format of a personal already-read item management table in the embodiment shown in FIG. 1;

FIG. 9 shows a format of a personal URL management table in the embodiment shown in FIG. 1;

FIG. 10 shows a format of a post management table (master) in the embodiment shown in FIG. 1;

FIG. 11 shows a format of a category table (master) in the embodiment shown in FIG. 1;

FIG. 12 illustrates a menu page in the embodiment shown in FIG. 1;

FIG. 13 illustrates a user authentication page in the embodiment shown in FIG. 1;

FIG. 14 illustrates the menu page in the embodiment shown in FIG. 1 after passing the user authentication processing;

FIG. 15 illustrates a mail contribution page in the embodiment shown in FIG. 1;

FIG. 16 illustrates a tool bar in the embodiment shown in FIG. 1;

FIGS. 17A through 17C illustrates respective operations in the embodiment shown in FIG. 1;

FIG. 18 illustrates an example of a mail header setting format in mail contribution in the embodiment shown in FIG. 1;

FIG. 19 shows an operation flow chart at a time of receiving a mail or a web contribution in the embodiment shown in FIG. 1;

FIG. 20 shows an operation flow chart at a time of document item selection in the embodiment shown in FIG. 1;

FIG. 21 shows an operation flow chart at a time of displaying a tool bar in the embodiment shown in FIG. 1;

FIG. 22 shows an operation flow chart of search processing in the embodiment shown in FIG. 1;

FIG. 23 shows an operation flow chart at a time of obtaining personally managed URLs in the embodiment shown in FIG. 1;

FIG. 24 shows a block diagram illustrating configuration examples of a server and a user's terminal in the embodiment shown in FIG. 1; and

FIG. 25 shows an operation flow chart illustrating interface operations between the server and the user's terminal shown in FIG. 24.

### DETAILED DESCRIPTION OF THE PREFERRED EMBODIMENT

As a preferred embodiment of the present invention, in order to achieve the above-mentioned object of the present invention, a system of providing a special ‘tool bar’ will now be described.

Throughout the specification, unless otherwise noted, the term ‘tool bar’ denotes a ‘tool bar’ configured as an operation and display functional part according to the embodiment of the present invention.

The tool bar in the embodiment of the present invention has an appearance and a function same as those of one which is generally recognized as a ‘tool bar’ when this term is used as a general term. However, the tool bar in the embodiment of the present invention has, as will be described later in details, a log-in function, and a predetermined homepage specially provided, for a particular user is made accessible through a log-in operation made by the user with a use of this tool bar. Then, with a use of this homepage, the user is allowed to utilize various functions such as a ‘mail contribution function’, a ‘keyword search function’ a ‘personal URL storage function’ and so forth according to the embodiment of the present invention.

The user of this tool bar should not necessarily perform a common operation of dispatching an electronic mail when performing a desired information dispatch operation, but merely should make a so-called Web contribution for a predetermined address. The information transmitted in this Web contribution is made accessible for another target user via a predetermined filtering operation or, the relevant information is made accessible for the other taget user only when predetermined requirements are met for the target user, or so. Further, as a specific manner of making the information accessible for the above-mentioned target user or so, the relevant information is made accessible via the above-mentioned tool bar of this target user and the homepage accompanying it. In case where the target user wishes to refer to the relevant information at this time, a so-called mail software may not necessarily be needed, but the information is accessible on the homepage accompanying the tool bar with a use of a common browser software or so.

In case of utilizing the above-mentioned ‘keyword search function’ on the homepage accompanying the tool bar with a use of the tool bar, a security policy which is previously set for each user by previously setting access permission requirements to be met when the relevant information is made accessible, is applied. Thereby, from among a large amount of information stored in a server, only a limited range of information which satisfies the security policy of each particular user is automatically extracted, and for this range of information thus extracted, keyword search is performed. Therefore, as the amount of information thus extracted is a limited amount accordingly, it is possible to effectively reduce a time required for the search operation. Furthermore, as the items of information thus obtained as a result of being hit from the predetermined keyword are basically ones within the limited range having a relevance to the particular user accordingly, it is possible to exclude items of information which have substantially no relevance to the particular user from being brought since the screening by means of the security policy is performed beforehand as mentioned above.

Furthermore, the above-mentioned log-in operation performed by the particular user is performed via any terminal apparatus basically as long as the terminal apparatus is connected to the relevant server which manages various sorts of information concerning the above-mentioned functions provided via the tool bar according to the embodiment of the present invention via a predetermined communication network. Specifically, in this server accessible by the particular user via the log-in operation, personal information and personal data (personal management information) for the particular user is managed, and, after the log-in operation is completed including a predetermined user authentication operation or so, the relevant personal information and personal data is applied for the particular user therethrough. As a result, various functions such as the above-mentioned ‘mail contribution function’, ‘keyword search function’, ‘personal URL storage function’ and so forth provided via the tool bar are made usable by the user, in the same manner as that in which the user uses these functions via his or her own terminal apparatus.

Furthermore, the user can determine whether or not the version of the homepage has been properly updated by referring to the homepage after completing the log-in operation. It is preferable that a function is provided such that, in case the version of the homepage is a still old one, a predetermined attention message urging the user to perform a predetermined version updating operation is automatically displayed on the homepage.

Furthermore, on this home page, from among a number of items of information stored in the server including contributions from respective users of the system or so, only respective document items of information such as electronic mails, Web contributions, or so, which have passed through the above-mentioned filtering or screening operation with a use of the security policy will be displayed as a list. A function is preferably provided such that, on the same homepage, a manner of display is applied, whereby document items which have been already read by the user are distinguishable from those which have not been read by the user yet as will be described later.

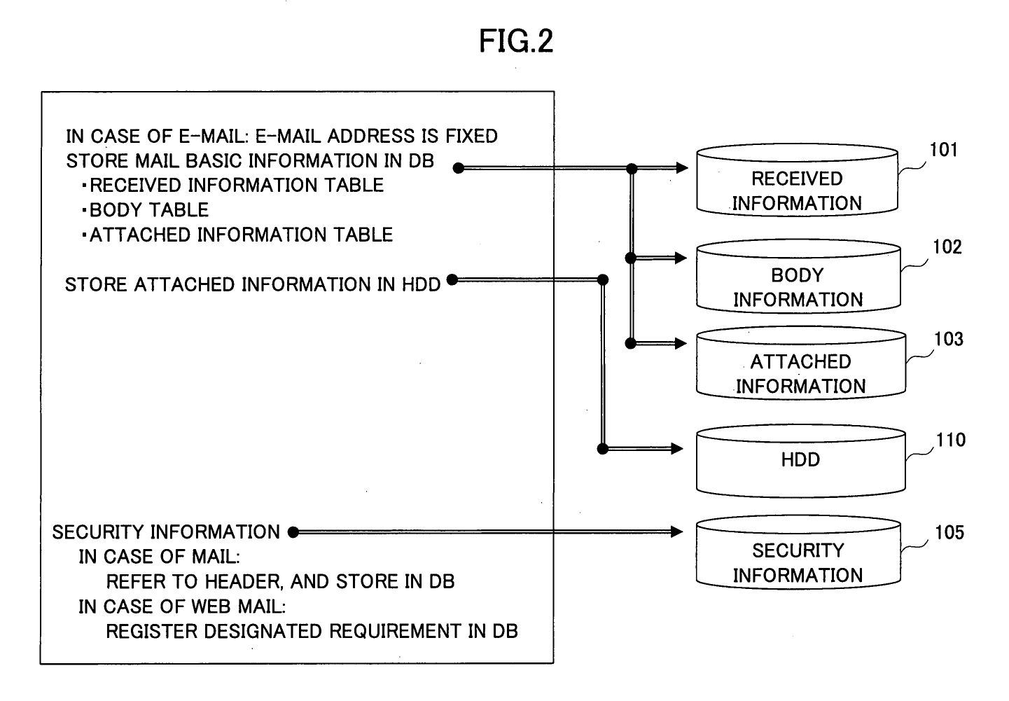

Thus, according to the preferable embodiment of the present invention, the tool bar with the security function (user authentication function), through which various functions such as a contribution (electronic mail) contents reference function, a keyword search function, a personal URL reference function and so forth can be used collectively via the tool bar is provided. There, each item of information contributed from each user of this system is written in databases according to a predetermined rule as shown in FIG. 2. The contents thus written in the databases are then sent to each user's terminal via a predetermined filtering or screening with a use of the security policy as mentioned above, and is displayed thereon.

A range of information for which the above-mentioned keyword search is applied is also defined by the security policy, and actual search is performed only within the range thus defined. Specifically, the entirety of the contributed information (including attached file information) is managed by a well-known manner of database application as will be described later.

Further, in the databases, a personal URL management table is provided, URLs are registered for each user there, and after that, the particular user can refer to these URLs registered if necessary as will be described later.

In case of utilizing the tool bar function according to the embodiment of the present invention in a manner in which a relevant software is embedded in an existing Web browser in a form of a plug-in software, it is preferable that a predetermined version search program is mounted accompanying the tool bar software, and therewith, the current version of the homepage is automatically checked each time the homepage is opened as mentioned above.

Further, it is preferable to provide a function by which, an item of information on the homepage which the user has read once is recorded in the database, and, the thus-recorded item of information is prevented from being displayed on the homepage again, for example, as will be described later. Furthermore, with a use of this function, it is also possible to provide another function by which the user who has once made a contribution can check whether the contributed information has been reviewed by another target user.

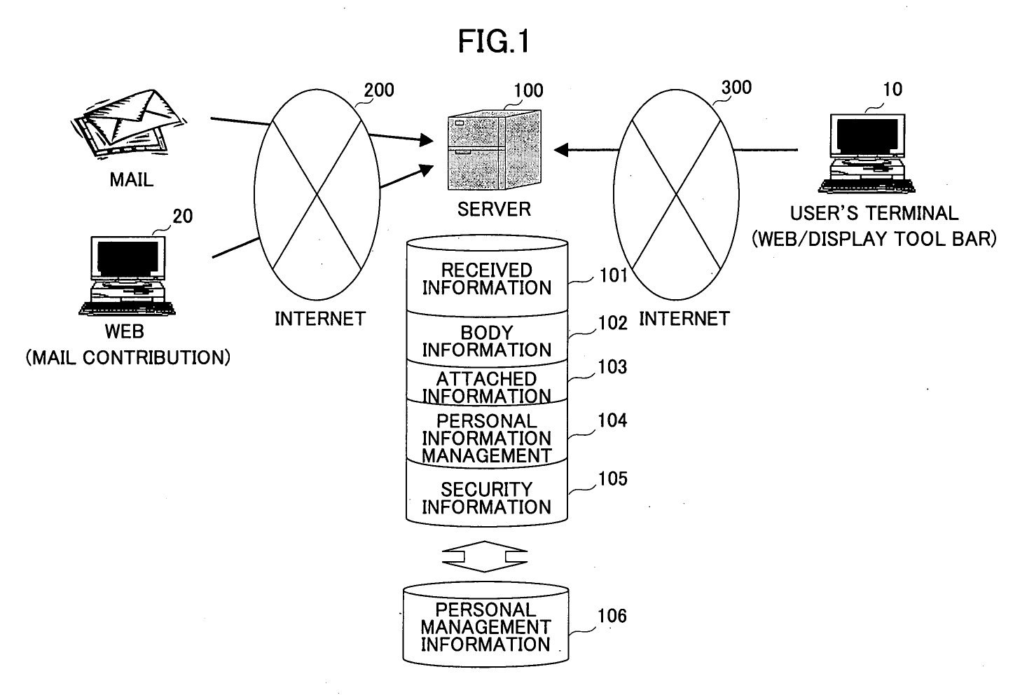

FIG. 1 shows a general system configuration of an information processing system in the embodiment of the present invention. As shown, this system includes an information processing server 100, respective user's terminals (for example, personal computers each having a communication function) 10, 20, . . . , and communication networks 200 and 300 such as the Internet which mutually connect the server 100 and user's terminals 10, 20, . . . . The server 100 includes, as will be described later, a received information database 101, a body information database 102, an attached file information database 103, a personal information management database 104, a security information database 105 and a personal management information database 106.

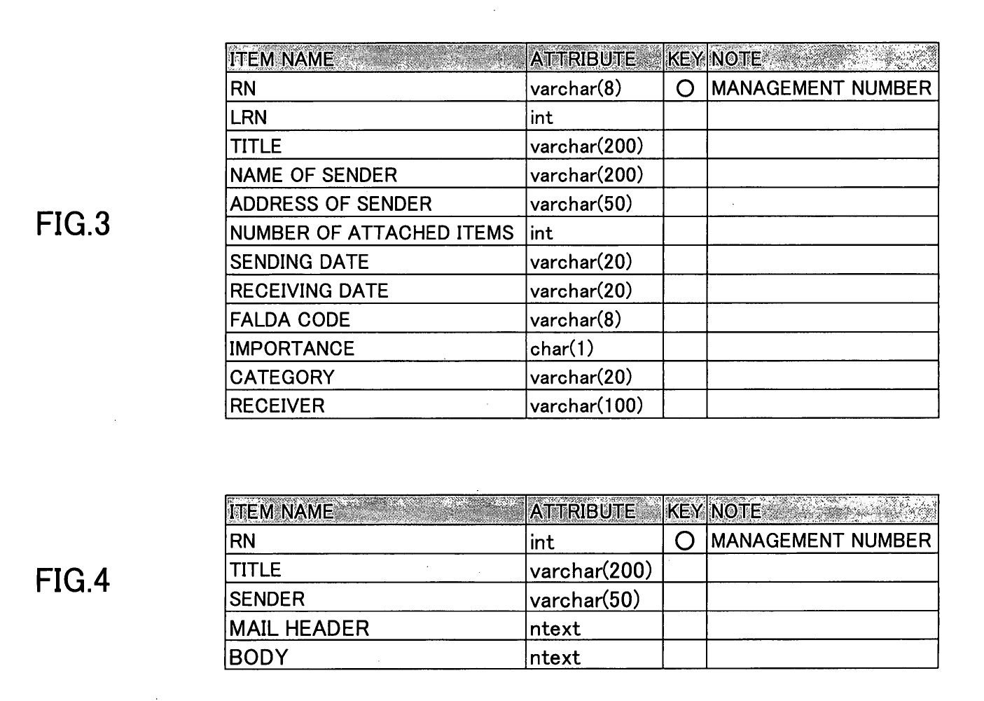

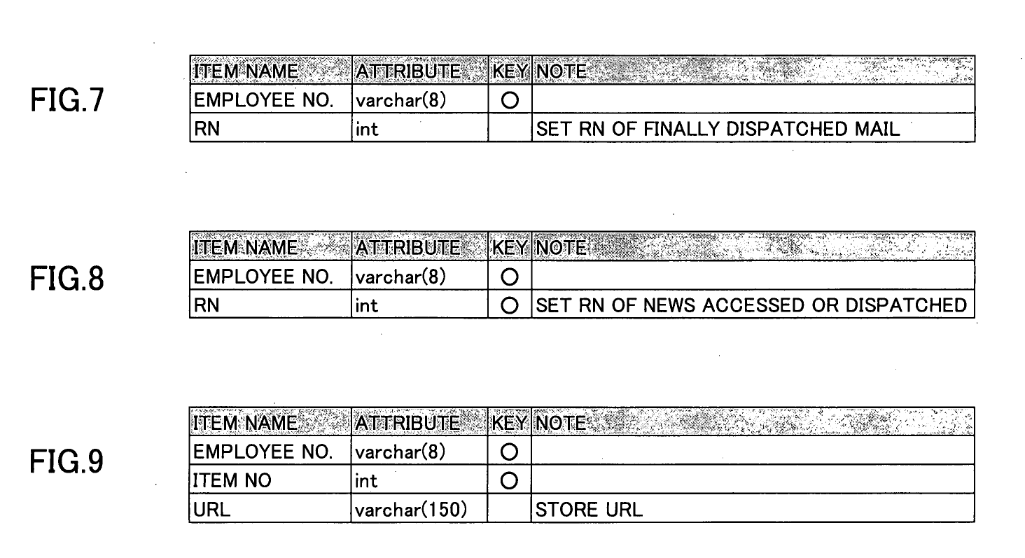

The received information database 101, the body information database 102, the attached file information database 103 are used to store therein respective items of information such as electronic mails, Web contributions and so forth (see FIGS. 3 through 5). The personal information database 104 is used to store therein person information for each user which will be described later (see FIGS. 7 through 9). The security information database 105 is used to achieve setting of the security policy for each user by setting access permission requirements therefor which will be described later. The personal management information database 106 is a database used in a case where the information processing system shown in FIG. 1 belongs to a system inside of a specific business enterprise or so, for managing personal management information of company employees who correspond to the users of the information processing system according to the embodiment of the present invention.

In case where this information processing system is the system inside of the business enterprise as mentioned above, each user is the company employee as mentioned above, and the personal management information for the company employees is already created by a predetermined a personal management division of the company and then is managed by the personal management information database 106. Therefore, when each user performs a log-in operation for utilizing the information processing system, authentication of the particular user can be achieved as a result of the personal management information thereof being referred to in the server 100. Furthermore, since the personal management information includes information of a section which each user belongs, a post thereof, and so forth registered therein, an accessible range of documents (electronic mails, Web contributions and so forth) which a particular user can access, can be defined for each user by comparing the above-mentioned personal management information (personal information) with the access permission requirements registered for each document in the security information database 105.

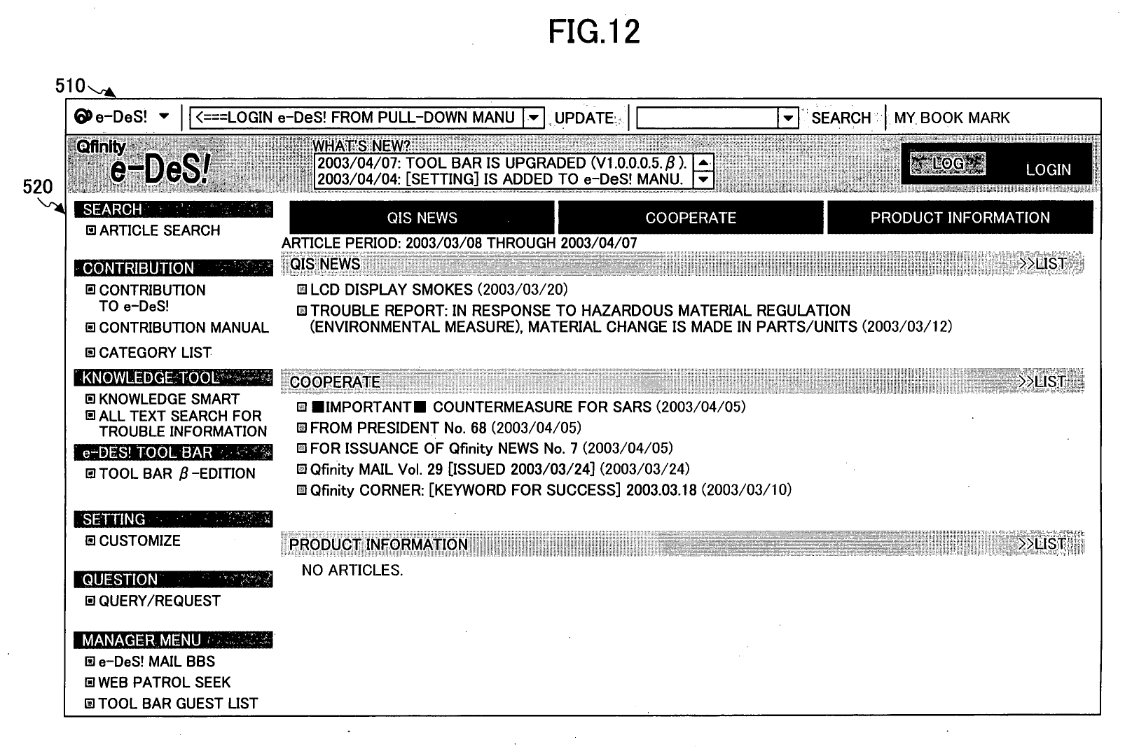

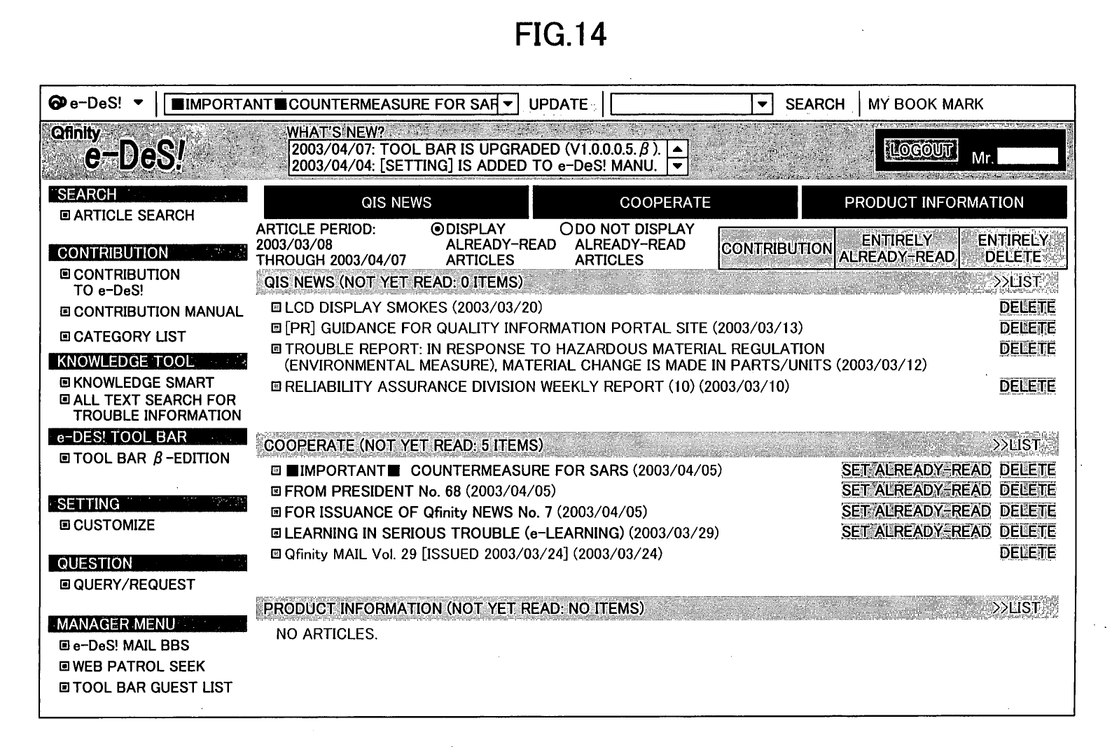

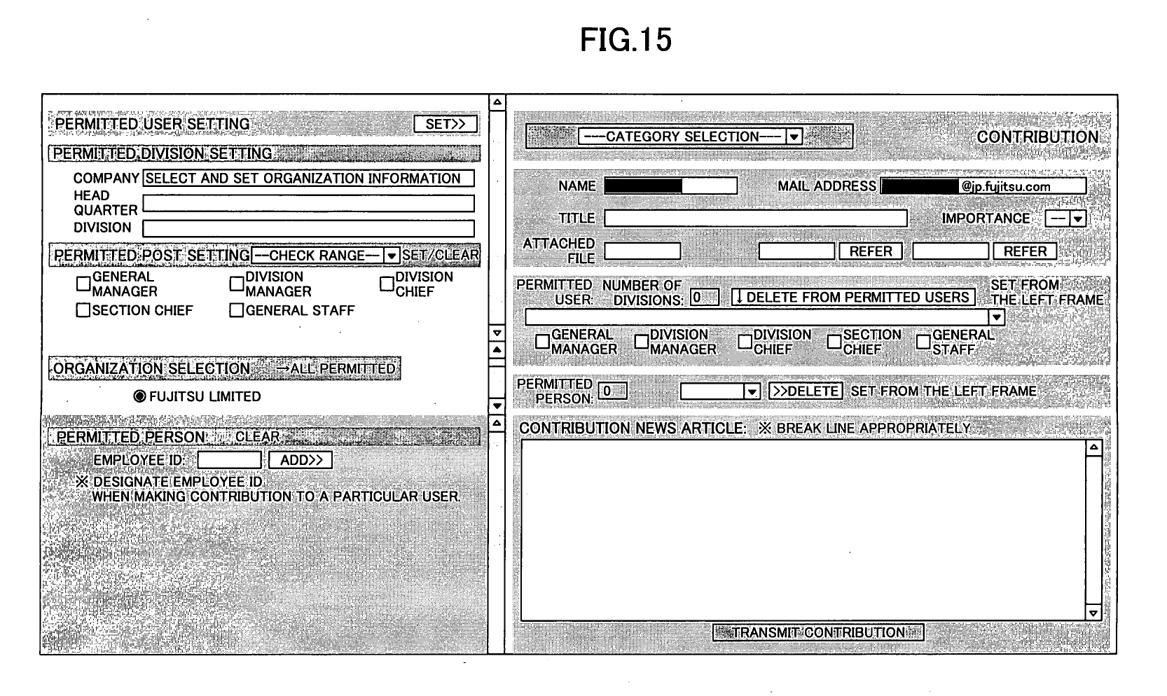

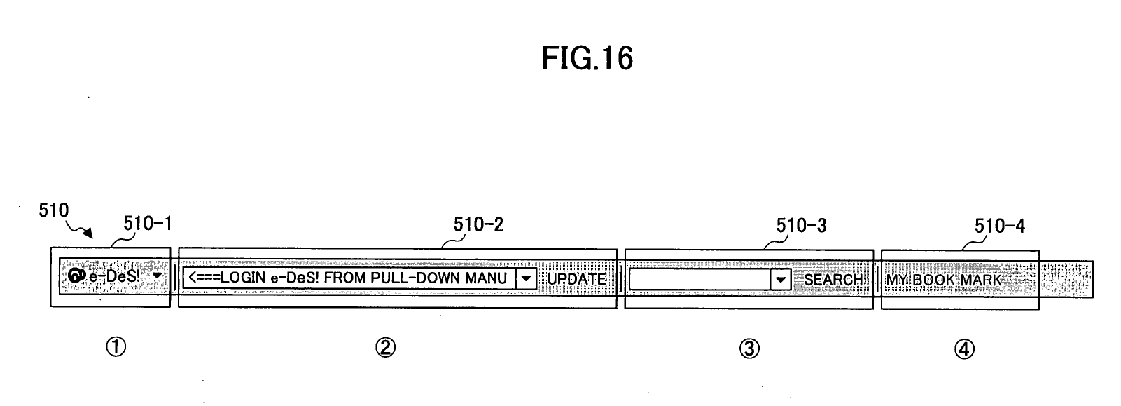

Each user uses the tool bar 510 (see FIGS. 12 and 16) provided for utilization of the information processing system in the embodiment on the own terminal 10, 20, . . . , or so (or by borrowing a terminal of another user), and performs log-in operation via the Internet 200/300. At this time, the server 100 refers to the personal management information database 106 and the security information database 105 as mentioned above, and determines an access permission range for the user (a range of documents which are made accessible for the particular user) who thus performed the log-in operation. That is, the server 100 determines the security policy to be applied for this particular user. Then, the server 100 returns, to the relevant terminal, the display contents (subject names of contributions, keyword search available items, personally registered URLs, and so forth) extracted within the thus-determined range which meets the relevant security policy thus determined. In the relevant user's terminal, the thus-returned contents are displayed on the screen (see FIG. 14). The user can also make registration for a Web contribution with a use of the thus-displayed page (see FIG. 15).

FIG. 2 shows details of received information storage operation performed in the server 100 according to the embodiment of the present invention. In case of receiving an electronic mail or a Web contribution, the contents thereof are stored and registered in the respective one of the above-mentioned databases 101, 102 or 103, as will be described later.

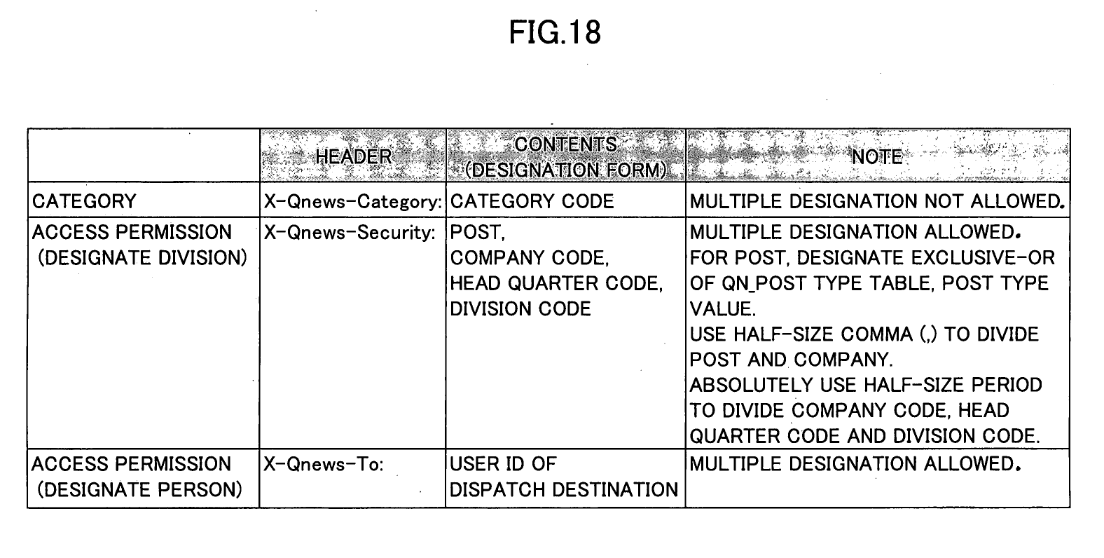

When a user will make a contribution via an electronic mail, predetermined information should be added to a header of the mail format (see FIG. 18). The contents added to the mail header may include ‘a category concerning the mail contents’ and ‘access permission range specification information’. The above-mentioned ‘category concerning the mail contents’ is information used by the server 100 for classifying the mail to be used for performing the above-mentioned filtering operation or so, which will be described later. The above-mentioned ‘access permission range specification information’ is used to specify the access permissible range by the user who thus makes the contribution. This specification may be made with designation of a certain group such as a specific section/division of the business enterprise or so, or designation of a specific personal name by which the relevant contribution information should be read.

For example, in case of designating a category with a category code of ‘004-000’ for ‘all the employees in a quality assurance division and a system evaluation control division’, the contents: ‘X-Category: 004-000’, ‘X-Qnews-Security: 31, 0001.1072.3232’ are added to the mail header. Alternatively, if, in addition thereto, the relevant user who makes the contribution permits Mr. A (user ID: 112233) and Mr. B (user ID: 445566) to access the relevant contribution information, the contents: ‘X-Category: 004-000, ‘X-Qnews-Security: 31, 0001.1072.3232’, ‘X-Qnews-To: 112233’ and ‘X-Qnews-To: 445566’ are added. In this case, each item of ‘X-Qnews-Security:’ or ‘X-Qnews-To:’ is needed for the number of destinations to be made.

In case of making Web contribution, a predetermined page for contribution shown in FIG. 15 is used. Specifically, same as in the above-mentioned case of mail contribution, designation of ‘category’, a designation of ‘access permission specification’ and the actual contribution contents are written into the form in the page shown in FIG. 15, and a contribution transmission button on the page shown is clicked. The information thus contributed is, as mentioned above, registered in the respective databases in the server 100 in the predetermined manner.

FIGS. 3 through 11 illustrate forms of the above-mentioned information tables stored in the respective databases of the server 100. FIG. 3 shows a record format of a received information table stored in the above-mentioned received information database 101. Information included in a received electronic mail or a received Web contribution other than the body information thereof, i.e., a management number (RN) designated for the relevant mail or Web contribution document, an internal management number thereof within the database system (LRN), a document title, a sender's name, a sender's address, . . . , an importance level, a category, a receiver's name are registered, as shown.

FIG. 4 illustrates a format of a body information table in the body information database 102 in which a body of the above-mentioned mail or Web contribution document received is recorded. That is, in this table, the above-mentioned internal management number (RN), the document title, the sender's name, the contents of the mail header, and the body contents are recorded respectively. FIG. 5 illustrates a format of an attached file table in the attached file information database 103 in which an attached file attached to the mail or Web contribution document received is stored. However, actually, since the attached file has relatively a large data size in general, as shown in FIG. 2, the substance thereof is actually stored in a hard disk drive (HDD) which is provided separately from the database system itself, and a file path reaching the thus-stored file substance, or so, is registered in this attached file table, whereby the relevant file substance is obtainable from the information registered in the attached file table.

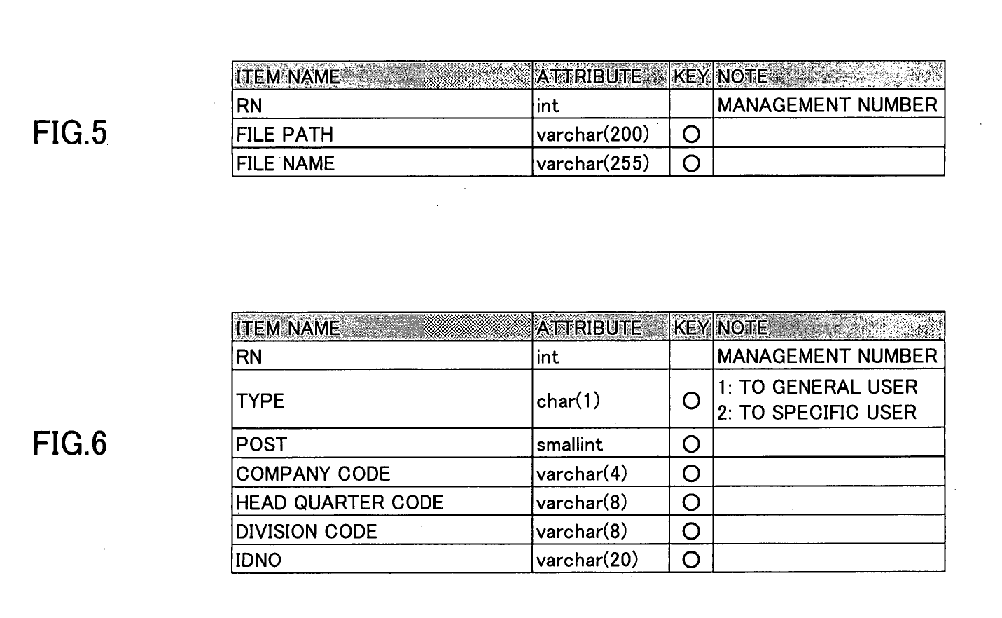

FIG. 6 illustrates a format of an access permission requirement table in which access permission requirements designated as described above for the relevant electronic mail or Web contribution stored in the server 100 is registered. This access permission requirement table is stored in the security information database 105 shown in FIGS. 1 and 2, and, therein, as described above with reference to FIGS. 15, 18 and so forth, the access permission requirements (for a specific group, a specific person, or so) set for each mail or Web contribution, are recorded for the relevant document. The internal management number RN registered in the tables shown in FIGS. 3 through 6 is information used for identifying each mail or Web contribution, and a unique number is assigned for each document as the internal management number.

FIGS. 7 through 9 illustrate respective formats of a personal dispatch information table (FIG. 7), a personal already-read item management table (FIG. 8) and a personal URL management table (FIG. 9) registered in the personal information management database 104. These respective tables are allocated for each of the users of the information processing system described above with reference to FIG. 1, i.e., the company employees of the business enterprise. Then, these tables are identified with the employee (ID) numbers allocated for the respective employees, and are used for determining the above-mentioned range of display information which is provided to the relevant user's terminal from the server 100.

In the personal dispatch information table shown in FIG. 7, the internal management number (same as that mentioned above) of the latest document (the electronic mail or Web contribution) dispatched by the server 100 to the user is recorded. In the personal already-read item management table, the internal management numbers of news items which have been already accessed by or dispatched to the relevant user for review are recorded. In the personal URL management table, URLs of Web for which the relevant user wishes to register are recorded.

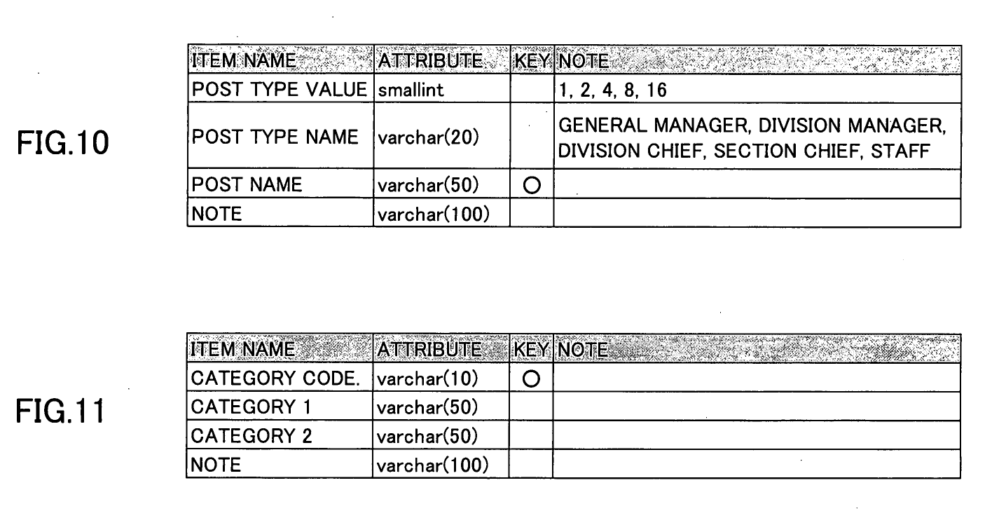

FIGS. 10 and 11 illustrate respective formats of a post type table and a category table which are also stored in the personal management information table 106 together with the above-mentioned personal information. This data is information used for managing a correspondence/relationship of a post type value and a category code actually written in the header of each document such as the electronic mail or the Web contribution with the actual post name and category name of the relevant user (sender).

The circles put in the key column in each of the above-mentioned tables shown in FIGS. 3 through 11 shows that the relevant items can be used as search keys in case of search operation for the relevant table.

FIG. 12 illustrates an example of a menu page displayed on the screen of each of the user's terminal (a terminal PC of each user, for example) 10, 20, . . . . This example is an example in which, the tool bar 510 according to the embodiment of the present invention such as that shown in FIG. 16 is inserted in a plug-in manner to a common Web page 520. Such a page (homepage) may be set as a page displayed first when a browser (software) is started, by providing appropriate setting in the browser previously in a common manner. Further, the tool bar 510 is reduced in its display size in a normal condition of operating another application software such as a word-processor software or so, and thus only a title part thereof 510-1 shown in FIG. 16 is displayed. Then, when this title part is clicked, the relevant homepage shown in FIG. 12 is displayed.

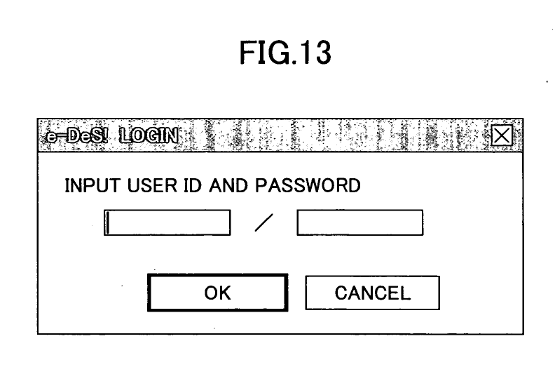

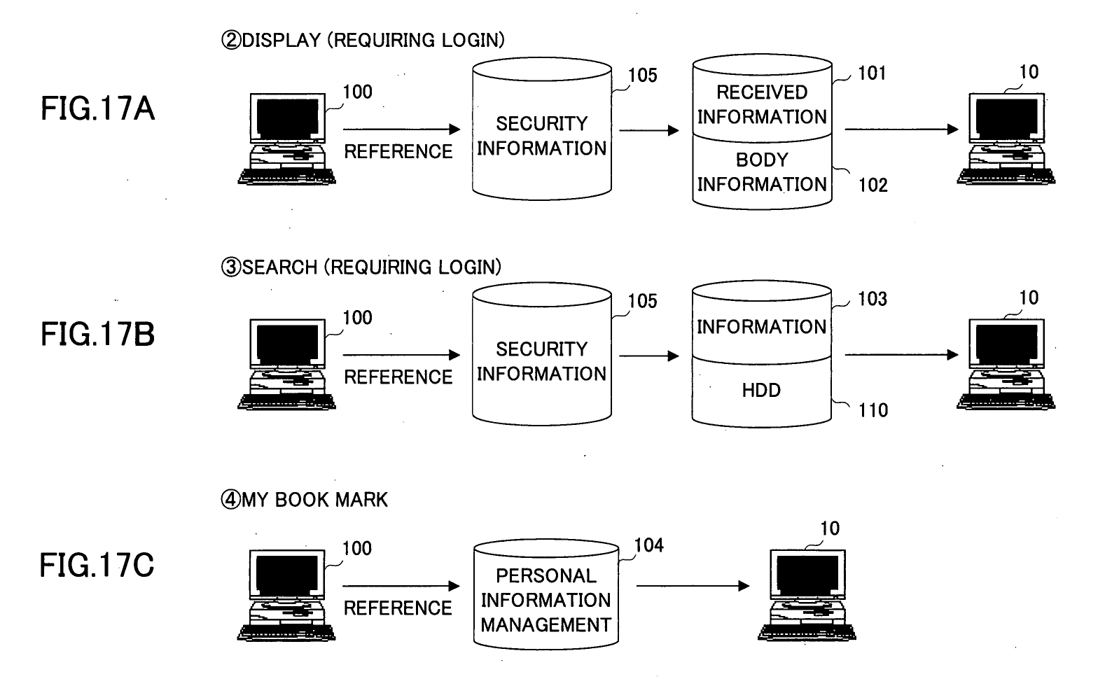

When a user performs log-in operation in this state shown in FIG. 12, the user should click a log-in part 510-2 shown in FIG. 16. Thereby, as shown in FIG. 13, a user authentication page is displayed. Then the user types a user ID and a password which are previously allocated for the user, in this page, and then, clicks an OK button shown. As a result, the thus-input information is sent to the server 100 via the Internet 200/300 shown in FIG. 1. In the server 100, predetermined authentication processing is performed for the user with the thus-received information. After this authentication processing is normally completed, as shown in FIG. 17A, the server 100 refers to the above-mentioned personal management information database 106 and the security information database 105, and defines the range of information which is permitted for this user to refer to. Specifically, in this case, the access permission requirement table in the security information database 105 shown in FIG. 6 is referred to, the access permission requirements previously set for each document in this table are compared with the personal data of this user previously registered in the personal management information database 106. Then, only for each document which thus meets the requirements, the relevant information is read out from the received information database 101 and the body information database 102, and the thus-obtained information is returned to the relevant terminal 10. As a result, on the terminal 10 of the relevant user, a user-authentication-completed page such as that shown in FIG. 14 is displayed.

Different from the menu page shown in FIG. 12, the user-authentication-completed page shown in FIG. 14 is configured specially for the particular user with a use of the access permission requirements set for each document such as those shown in FIG. 6 and the information registered in the personal information database shown in FIGS. 7 through 9 for the relevant user, since the above-mentioned comparison operation has been performed in the server 100 for determining the range of information to be dispatched to the user's terminal. Further, as shown in FIG. 14, on the user-authentication-completed page, whether or not the contents of each article's item have been already reviewed by the relevant user who is thus authenticated is distinguishably indicated in a manner of controlling the darkness of the displayed texts. Furthermore, the news items which have been already deleted by the relevant user are not displayed in this example, as will be described later.

As an electronic mail contribution or a Web contribution may be received at every time it is preferable that the server 100 performs the operation of FIG. 17A for a homepage of each user such as that shown in FIG. 14, i.e., searching the stored contents of mails and Web contributions for a document of a mail or a Web contribution which has the access permission requirements newly met by the personal data of the relevant user, and dispatching the document thus searched for if any to the terminal of the relevant user, on which terminal the news item of the thus-received contents is newly displayed in the homepage of the relevant user, periodically. In this case it is preferable that the frequency at which these operations are performed is variably set by the relevant user.

A keyword search operation available on the user-authentication-completed page shown in FIG. 14 will now be described. When the user inputs a keyword, as shown in FIG. 17B, the server 100 receiving this information compares the personal data of the user (already obtained at the time of authentication operation as mentioned above) with the access permission requirements previously set for each document in the above-mentioned access permission requirement table as mentioned above. Then, the data which meets the requirements is read out from the hard disk drive (HDD) 110 with a use of the information in the attached file table (see FIG. 5). Then, the server 100 performs keyword search within the range of information thus read out from the HDD 110. Then, files which are hit thereby are returned to the relevant terminal 10 as a search result. The user can thus obtain these files on the terminal 10 as will be described later.

A function of obtaining URL information previously registered by the user and available on the user-authentication-completed page shown in FIG. 14 will now be described. As shown in FIG. 17C, the server 100 refers to the personal URL management table shown in FIG. 9 registered for the relevant user stored in the personal information database 104 in response to a request from the user's terminal 10, reads out the URL information therefrom, and returns it to the user's terminal 10. As a result, the user can obtain his or her registered URL information, as will be described later.

It is preferable that, while the user-authentication-completed page shown in FIG. 14 is displayed on the screen of the user's terminal 10, the server 100 refers to the personal already-read item management table described above with reference to FIG. 8. Then, actual display of this page is performed in a manner such that, for each of the documents, item names of which have been dispatched to this user's terminal from the server 100 through the operation described above with reference to FIG. 17A, whether or not the contents thereof have been already read by the user is distinguishable. In the example shown in FIG. 14, as mentioned above, the document items for which the contents thereof have been already read by the user are displayed in light texts (all the four items in the upper column of ‘QIS NEWS and the last item in the lower column of ‘CORPORATE’ in this example shown), while, for the other items for which the contents have not been read, the items are displayed in dark texts, as shown. Actually, when the user clicks the relevant text part ‘SET ALREADY-READ’ for each item, in the right hand of the page, the item is turned into light texts, and when the text part ‘DELETE’ is clicked, the relevant item is deleted from the page. Furthermore, when the user checks the box of the item ‘DO NOT DISPLAY ALREADY-READ ARTICLES’ in the top of the page, the already-read document items are thus made not displayed on the page.

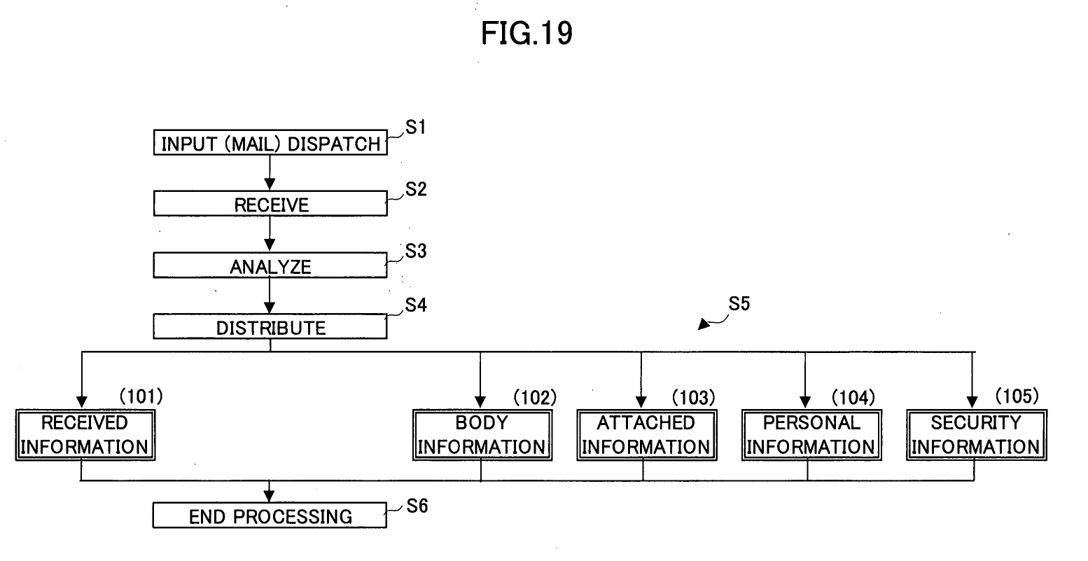

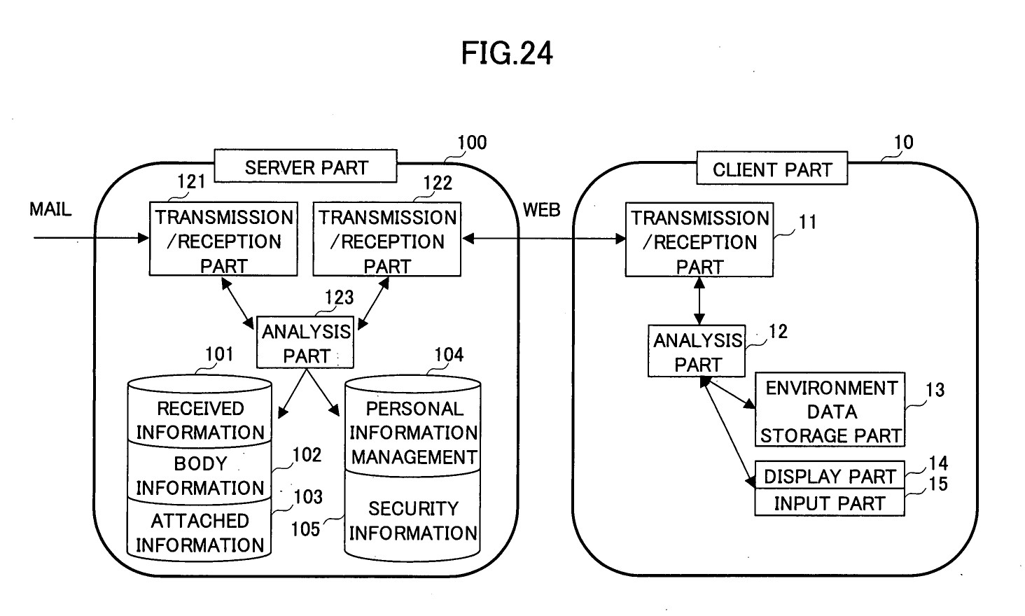

With reference to FIGS. 19 through 24, particular operations in the embodiment of the present invention will now be described. FIG. 19 shows operations in case where the server 100 receives the electronic mail or Web contribution from the user's terminal 10. The mail or Web contribution received in Step S1 is received by a transmission/reception part 121 or 122 in the server 100 in Step S2, the contents thereof are analyzed by an analysis part 123 in Step S3, and are then stored in the respective one of the above-mentioned databases 101, 102, 103, 104 and 105 in the above-mentioned manner according to the analysis result, in Steps S4 and S5.

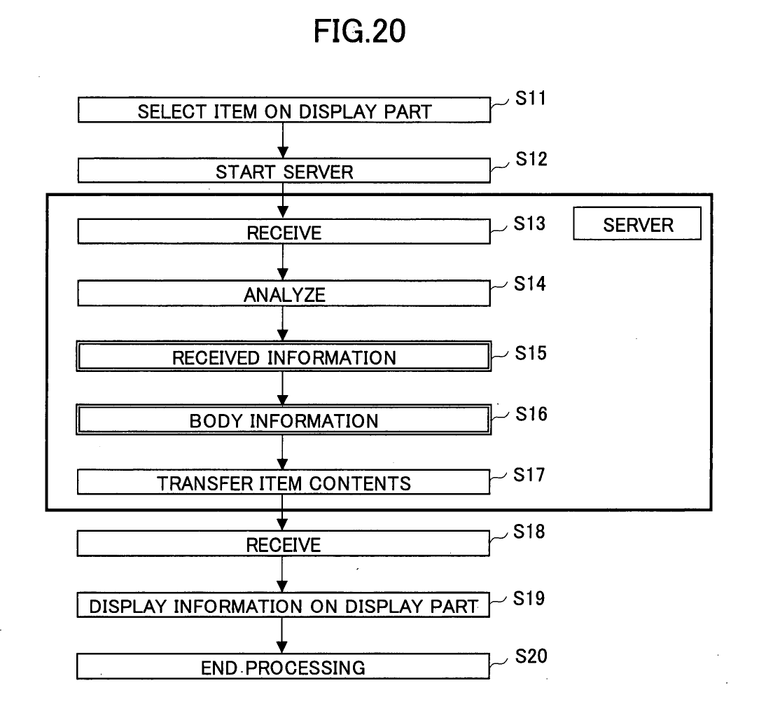

FIG. 20 shows operations in a case where the user clicks one of the items of documents listed in the user-authentication-completed page such as that shown in FIG. 14 for the purpose of bringing the contents thereof from the server 100 to read. In Step S11, the user clicks the relevant item of document in the user-authentication-completed page with a use of an input part 15 (a mouse or so). Thereby, in Step S12, thus-given instructions start up the server 100, and in Step S13, these instructions are received by the transmission/reception part 122 in the server 100. The contents thereof are then analyzed by the analysis part 123 in Step S14, and the specific document name of the item selected by the user obtained from the analysis is used as a key to search the received information table shown in FIG. 3. Thereby, the relevant internal management number RN is obtained in Step S15, and this management number RN is then used as a key to search the body information table shown in FIG. 4. Thereby, the relevant body information is obtained in Step S16. The thus-obtained information is returned to the user's terminal 10 via the transmission/reception part 122 in Step S17. The thus-transmitted information is received by a transmission/reception part 11 in the user's terminal 10, is analyzed by an analysis part 14 there and after that, is displayed on a display part 14 of the user's terminal in Step S19.

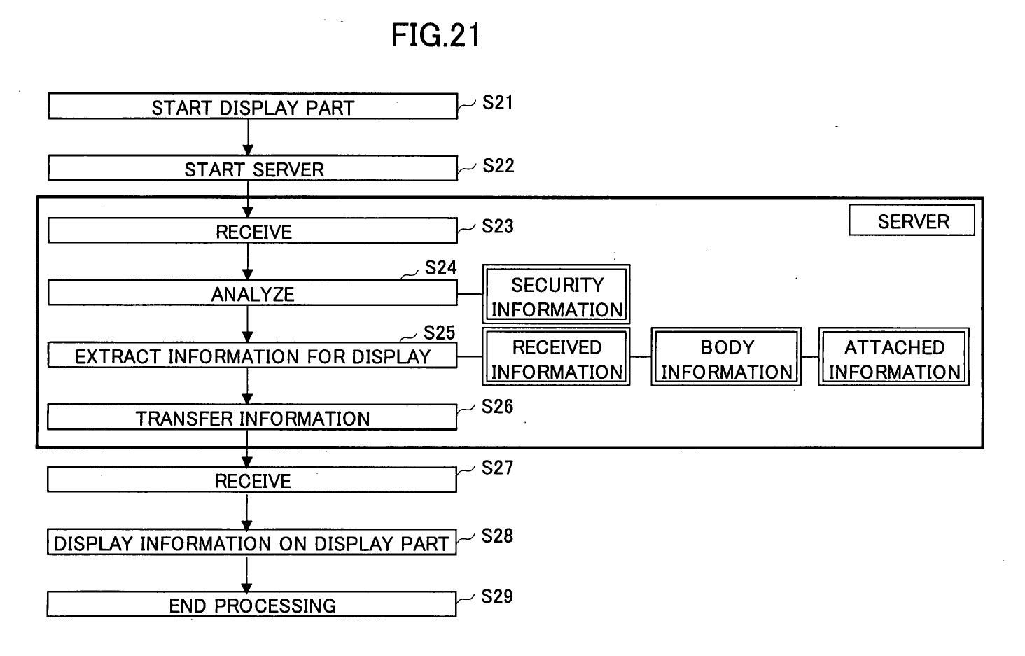

FIG. 21 shows operations performed when the user performs log-in operation in the user's terminal 10, and causes the user-authentication-completed page such as that shown in FIG. 14 to be displayed thereon. First, the user starts up the display part 14, and performs the authentication operation with a use of the input part 15 in Step S21. Thereby, the thus-given information is sent out to the server 100 and received by the transmission/reception part 122 in the server 100, and is analyzed by the analysis part 123 in Steps S22, S23 and S24. There, the predetermined authentication processing is performed in the server 100, and after it is completed normally, the personal data of the relevant authenticated user from the personal information management database 104 is compared with the access permission requirements of the respective documents from the security information database 105. Thereby, it is determined for each document whether or not it should be made accessible for the relevant user. The information belonging to the thus-determined range of documents are extracted from the received information database 101, the body information database 102 and the attached information database 103 in sequence in Step S25. The thus-extracted information is then transferred to the relevant user's terminal 10, is received by the transmission/reception part 11 of the terminal 10 and is displayed on the display part 14 thereof in Steps S27 and S28.

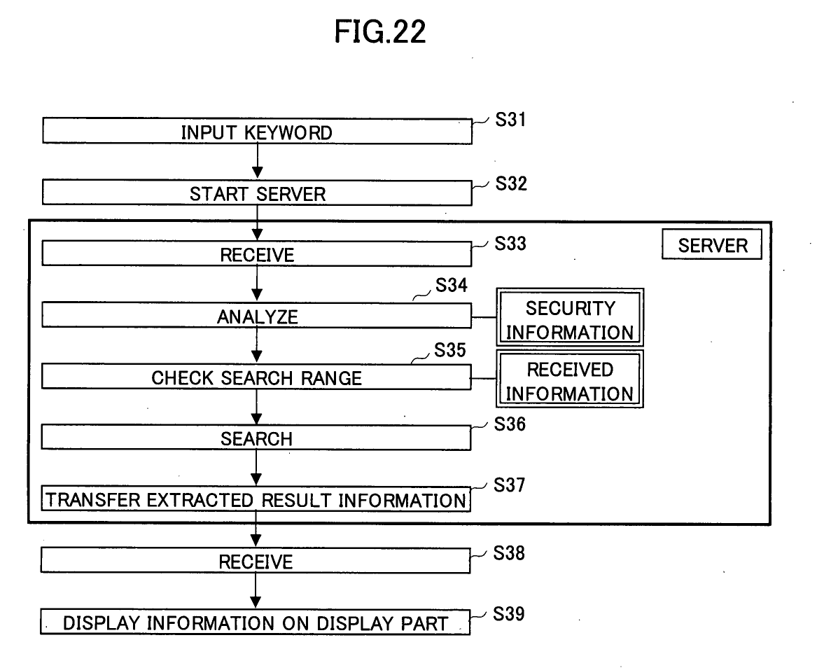

FIG. 22 shows the operations performed when the user performs keyword search operation on the above-mentioned user-authentication-completed page such as that shown in FIG. 14. When the user performs keyword input operation into this page on the terminal 10 so as to initiate keyword search operation in Step S31, the thus-given instructions are transferred to the server 100 which is thereby started up in Step S32. Then, the analysis part 123 in the server 100 compares the personal data of the user with the security information as mentioned above in Step S34. After that, the analysis part 123 performs keyword search operation within the range of information meeting the relevant security requirements as mentioned above in Step S36. The thus-extracted search result is then transferred to the user's terminal 10 in Step S37, is received by the user's terminal 10 in Step S38, and is displayed there in Step S39.

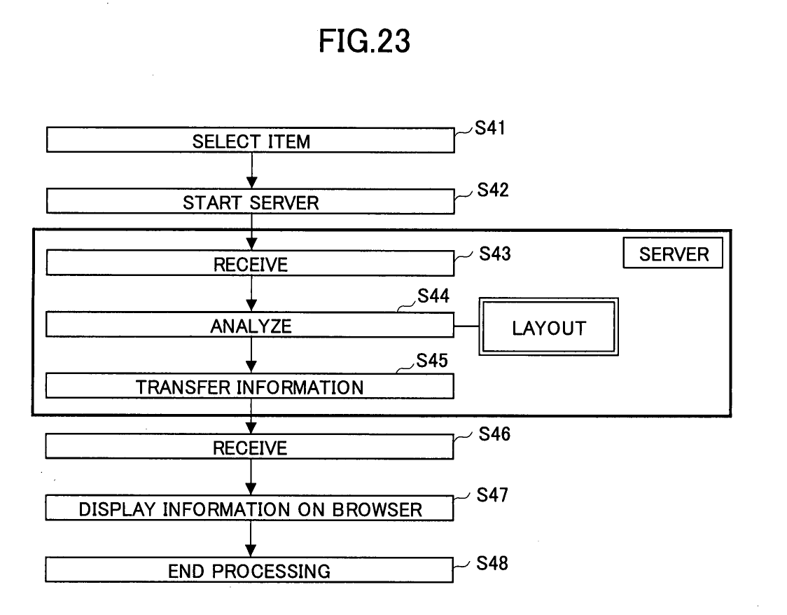

FIG. 23 shows operations of reading personally registered URLs. When the user inputs instructions into the user's terminal 10 on the above-mentioned user-authentication-completed page for obtaining the personally registered URLs in Step S41, the server 100 is started up in Step S42. Then, the thus-given instructions are analyzed by the analysis part in the server 100 in Steps S43 and S44, and the relevant personal URL management table such as that shown in FIG. 9 is extracted from the personal information management database 104 in Step S45. Then, the personally registered URLs read out from the relevant personal URL management table are returned to the user's terminal 10 in Step S46 and are then displayed on the user's terminal 10 in Step S47. The user may select a desired URL therefrom, and thereby, relevant homepage information is obtained via the Internet through the browser in a well-know manner, and then, is displayed on the user's terminal 10.

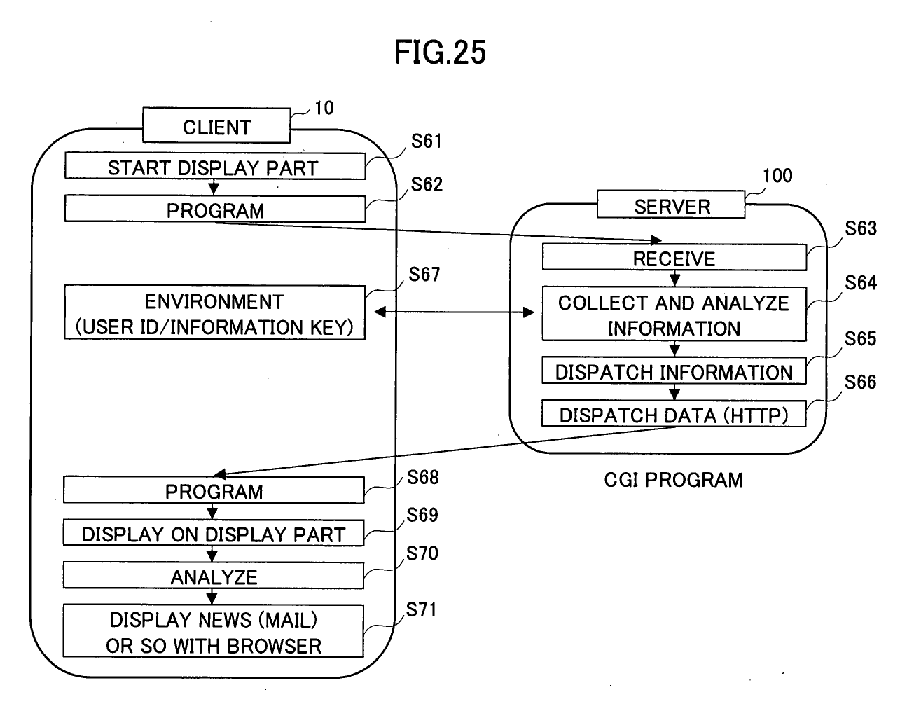

FIG. 25 illustrates interface operations between the server 100 and each user's terminal 10 in the embodiment of the present invention. When the display part 14 is started up in the user's terminal 10 in Step S61, a tool bar function starting program according to the embodiment of the present invention previously installed in this terminal 10 is started up in Step S62. As a result, predetermined tool bar display instructions are sent to the server 100, and then are received by the server 100 in Step S63. In the user's terminal 10, when authentication operation is performed by the user in response to instructions given by the server 100 for this purpose in Step S67, information input from the user in the user's terminal 10 in this response is then sent to the server 100 which then analyses it in Step S64. Then, when the authentication processing is normally completed as a result, the information to be dispatched to the relevant user is extracted in the server 100 in Step S65, and the thus-extracted information is sent to the user's terminal 10 as mentioned above according to an HTTP (hyper text transfer protocol) in Step S66. The tool bar function starting program in the user's terminal 10 which thus receives it analyses the thus-dispatched data, and displays the thus-dispatched contents on the display part 14 in Steps S68 and S69. At this time, the tool bar function starting program analyses the dispatched data as is needed in Step S70, and displays the dispatched contents such as the electronic mail or Web contributions or so from the server 100, on the user-authentication-completed page according to a predetermined page layout process in Step S71 (see FIG. 14). As a software program in the server 100 for causing the server computer to execute the above-mentioned steps S62 through S66 or so, for example, a well-known CGI (common gateway interface) may be applied, for example.

Thus, according to the embodiment of the present invention, the security requirements in the tool bar can be set for each individual user, and thus, the user should refer only to the necessary information. Furthermore, when borrowing a terminal machine of another user, the functions of the tool bar according to the embodiment of the present invention such as to obtain electronic mail/Web contribution information, to execute keyword search, to utilize the personally registered URLs or so, can be utilized in the same manner as that in case of using the own terminal machine.

Furthermore, each user should not necessarily dispatch an electronic mail to a specific target user, but merely should make a Web contribution with predetermined access permission requirements. Thereby, the relevant target user can refer to the contents thus given, via the tool bar. Accordingly, the system users become free from a troublesome mail management work otherwise necessary in the conventional art.

A Web browser is not necessary required for embodying the embodiment of the present invention. For example, as long as an HTTP usable environment is provided, for example, the tool bar function according to the embodiment of the present invention described above can be easily embodied merely with a use of predetermined plug-in type software.

In fact, the procedures/functions executed by each of the above-mentioned server 100 and each user's terminal 10 described above with reference to FIGS. 17A through 25 may be achieved by installing respective software programs in the respective computers which act as the server and the user's terminals. Each computer thus has a relevant software program installed therein executes instructions included in the program with its own CPU as in a well-known general-purpose computer's task processing manner, and thus, performs the respective operations so as to execute the necessary functions. These software pogroms may be installed in these respective computers through predetermined computer-readable information recording media, such as CD-ROMs, or so, from which the CPUs thereof read out the programs, and install them into their own hard disk devices or so. After that, the CPUs read out the instructions therefrom, and execute them in cooperation with other auxiliary devices such as RAMs, ROMs, and so forth. It is also possible that these necessary software programs may be downloaded to these computers via a predetermined communication network such as a backbone network, i.e., the Internet, or any other local network, instead of utilization of the above-mentioned computer readable information recording media such as CD-ROMs.

The present invention is not limited to the above-described embodiment, and variations and modifications may be made without departing from the claimed scope of the present invention.

The present application is based on Japanese priority application No. 2003-359121, filed on Oct. 20, 2003, the entire contents of which are hereby incorporated by reference.

1. An information reference apparatus comprising:
a reference information storage part storing predetermined reference information;
a reference range defining information storage part storing predetermined reference range defining information; and
a reference range defining part referring to the reference range defining information stored for a user by said reference range defining information storage part and defining a range of the reference information stored by said reference information storage part, in which range the reference information is available for the user to refer to.

2. The information reference apparatus as claimed in claim 1, further comprising:
a contribution receiving part receiving a contribution from a user and storing the contribution in said reference information storage part.

3. The information reference apparatus as claimed in claim 1, further comprising:
an authenticating part allowing a user to refer to the reference information after an authentication of the user is normally finished.

4. The information reference apparatus as claimed in claim 1, further comprising:
a search range defining part responsive to a search request from a user's apparatus for referring to the reference range defining information from said reference range defining information storage part, and thereby defining a range of the reference information, in which range the reference information is available for the search.

5. The information reference apparatus as claimed in claim 1, further comprising:
an URL management part registering an URL for each user, and being responsive to an URL reference request sent from a user's apparatus via a communication network for returning to the apparatus, information of URL previously registered for the relevant user.

6. The information reference apparatus as claimed in claim 1, wherein:
each user is given an attribute, and a user who makes a contribution is allowed to define a range of users who are allowed to refer to information included in the contribution, by designating the attribute thus given to the users.

7. The information reference apparatus as claimed in claim 1, further comprising a referred information managing part storing information for determining whether or not an item of the reference information has been already referred to by a specific user, and enabling said specific user to determine that the item of reference information has been already referred to by himself or herself with a use of the thus-stored information, upon receiving a reference request from the specific user.

8. The information reference apparatus as claimed in claim 1, wherein:
the reference range defining information comprises information designating, for each item of the reference information, a range of users who are allowed to refer thereto, a determination as to whether or not each item of the reference information is available for a particular user being made by determining whether or not an attribute set for the particular user is included in said range of users designated for said item of the reference information.

9. An information reference system comprising:
a reference information storage part storing predetermined reference information;
a reference range defining information storage part storing predetermined reference range defining information; and
a reference range defining part referring to the reference range defining information stored for a user by said reference range defining information storage part and defining a range of the reference information stored by said reference information storage part, in which range the reference information is available for the user to refer to.

10. The information reference system as claimed in claim 9, further comprising:
a contribution receiving part receiving a contribution from a user and storing the contribution in said reference information storage part.

11. The information reference system as claimed in claim 9, further comprising:
an authenticating part allowing a user to refer to the reference information when an authentication for the user is normally finished.

12. The information reference system as claimed in claim 9, further comprising:
a search range defining part responsive to a search request from a user's apparatus for referring to the reference range defining information from said reference range defining information storage part, and thereby defining a range of the reference information stored in the reference information storage part, in which range the reference information is available for the search.

13. The information reference system as claimed in claim 9, further comprising:
an URL management part registering an URL for each user, and being responsive to an URL reference request sent from a user's apparatus via a communication network for returning, to the user's apparatus, information of URL previously registered for the user.

14. The information reference system as claimed in claim 9, wherein:
each user is given an attribute, and a user who makes a contribution is allowed to define a range of users who are allowed to refer to information included in the contribution, by designating the attribute thus given to the users.

15. The information reference system as claimed in claim 9, further comprising a referred information managing part storing information for determining whether or not an item of the reference information has been already referred to by a specific user, and enabling said specific user to determine that the item of reference information has been already referred to by himself or herself with a use of the thus-stored information, upon receiving a reference request from the specific user.

16. The information reference system as claimed in claim 9, wherein:
the reference range defining information comprises information designating for each item of the reference information a range of users who are allowed to refer to said item of the reference information, a determination as to whether or not each item of the reference information is available to be referred to by a particular user being made by determining whether or not an attribute set for said particular user is included in said range of users thus designated for said item of the reference information.

17. An information reference program causing a computer to execute the steps of:
a) storing predetermined reference information in a reference information storage part;
b) storing predetermined reference range defining information in a reference defining information storage part; and
c) referring to the reference range defining information stored for a user in said reference range defining information storage part and defining a range of the reference information stored in said reference information storage part, in which range the reference information is available for the user to refer to.

18. The information reference program as claimed in claim 17, further causing the computer to execute the step of:
d) receiving a contribution from a user and storing the contribution in said reference information storage part.

19. The information reference program as claimed in claim 17, further causing the computer to execute the step of:
d) allowing a user to refer to the reference information stored in the reference information storage part when an authentication for the user is normally finished.

20. The information reference program as claimed in claim 17, further causing the computer to execute the step of:
d) responsive to a search request from a user's apparatus, referring to the reference range defining information from said reference range defining information storage part, and thereby defining a range of the reference information stored in the reference information storage part, in which range the reference information is available for the search.

21. The information reference program claimed in claim 17, further causing the computer to execute the step of:
d) registering an URL for each user, and being responsive to an URL reference request sent from a user's apparatus via a communication network for returning, to the user's apparatus, information of URL previously registered for the user.

22. The information reference program as claimed in claim 17, causing the computer to execute the step of:
d) providing each user with an attribute, and allowing a user who makes a contribution to define a range of users who are allowed to refer to information included in the contribution, by designating the attribute thus given to the users.

23. The information reference program as claimed in claim 17, further causing the computer to execute the step of:
d) storing information for determining whether or not an item of the reference information has been already referred to by a specific user, and enabling said specific user to determine that the item of reference information has been already referred to by himself or herself with a use of the thus-stored information, upon receiving a reference request from the specific user.

24. The information reference program as claimed in claim 17, further causing the computer to execute the steps of:
d) creating the reference range defining information to comprise information designating for each item of the reference information a range of users who are allowed to refer to said item of the reference information, and making a determination as to whether or not each item of the reference information is available to be referred to by a particular user by determining whether or not an attribute set for said particular user is included in said range of users thus designated for said item of the reference information.

25. A computer readable information storage medium storing therein the program claimed in claim 17.

26. A computer readable information storage medium storing therein the program claimed in claim 18.

27. A computer readable information storage medium storing therein the program claimed in claim 19.

28. A computer readable information storage medium storing therein the program claimed in claim 20.

29. A computer readable information storage medium storing therein the program claimed in claim 21.

30. A computer readable information storage medium storing therein the program claimed in claim 22.

31. A computer readable information storage medium storing therein the program claimed in claim 23.

32. A computer readable information storage medium storing therein the program claimed in claim 24.

33. An information reference method comprising the steps of:
a) storing predetermined reference information in a reference information storage part;
b) storing predetermined reference range defining information in a reference defining information storage part; and
c) referring to the reference range defining information stored for a user in said reference range defining information storage part and defining a range of the reference information stored in said reference information storage part, in which range the reference information is available for the user to refer to.

34. The information reference method as claimed in claim 33, further comprising the step of:
d) receiving a contribution from a user and storing the contribution in said reference information storage part.

35. The information reference method as claimed in claim 33, further comprising the step of:
d) allowing a user to refer to the reference information stored in the reference information storage part when an authentication for the user is normally finished.

36. The information reference method as claimed in claim 33, further comprising the step of:
d) responsive to a search request from a user's apparatus, referring to the reference range defining information from said reference range defining information storage part and thereby defining a range of the reference information stored in the reference information storage part, in which range the reference information is available for the search.

37. The information reference method as claimed in claim 33, further comprising the step of:
d) registering an URL for each user, and being responsive to an URL reference request sent from a user's apparatus via a communication network for returning, to the user's apparatus, information of URL previously registered for the user.

38. The information reference method as claimed in claim 33, further comprising the step of:
d) providing each user an attribute, and allowing a user who makes a contribution to define a range of users who are allowed to refer to information included in the contribution, by designating the attribute thus given to the users.

39. The information reference method as claimed in claim 33, further comprising the step of:
d) storing information for determining whether or not an item of the reference information has been already referred to by a specific user, and enabling said specific user to determine that the item of reference information has been already referred to by himself or herself with a use of the thus-stored information, upon receiving a reference request from the specific user.

40. The information reference program as claimed in claim 34, further comprising the step of:
d) creating the reference range defining information to comprise information designating for each item of the reference information a range of users who are allowed to refer to said item of the reference information, and making a determination as to whether or not each item of the reference information is available to be referred to by a particular user by determining whether or not an attribute set for said particular user is included in said range of users thus designated for said item of the reference information.
